(19) United States
(12) Patent Application Publication
(10) Pub. No.: US 2002/0118115 A1
(43) Pub. Date: Aug. 29, 2002

(54) Infrasound sensor

(76) Inventor: Robert E. Schendel, Kingwood, TX (US)

Correspondence Address: SHARON E. LYTLE, MCGLINCHEY STAFFORD, 1001 MCKINNEY, SUITE 1500, HOUSTON, TX, 77002, US

(21) Appl. No.: 09/797,354

(22) Filed: Feb. 28, 2001

(51) Int. Cl. G08B 21/00

(52) U.S. Cl. 340/626; 367/94; 340/541

(57) ABSTRACT

An infrasonic pressure wave sensor apparatus is provided to detect infrasonic pressure waves generated by such means as an air-burst detonation. The infrasonic pressure wave sensor comprises a Doppler transceiver utilizing a microwave emitting device, such as a Gunn diode, and a microwave receiving device, such as a receiver diode. The infrasonic pressure wave sensor also comprises a reflective diaphragm, such as a conductive rubber or conductive plastic diaphragm. The microwave emitting device and microwave receiving device cooperate to measure the deflections in the reflective diaphragm as the reflective diaphragm is exposed to infrasonic pressure waves. The infrasonic pressure wave sensor yields a 2 V signal while remains extremely sensitive to pressure waves having a frequency of less than 1 Hz.

### BACKGROUND OF THE INVENTION

1. Field of the Invention

The present invention relates to pressure wave detection devices and, more particularly, to infrasonic pressure wave sensors. Infrasonic sensors are used to detect and measure pressure signatures created by air-burst activity.

2. Description of the Prior Art

Pressure wave sensing devices are used in numerous applications today—from intruder detection to air-burst explosion ascertainment. In general, pressure wave detection devices employ a diaphragm exposed to an external pressure wave source and a means for reading the deflections of the diaphragm. As the pressure waves impact the sensing device, a mechanical deflection of the diaphragm occurs with an amplitude proportional to the intensity of the pressure wave. Various means have been employed in the past to read the deflections of the diaphragm including strain gauge instruments, capacitor plates, and pick-up coils. Also, devices in the prior art have utilized thick, metal diaphragms to receive the pressure waves. These prior art devices, however, have only been capable of yielding very low voltage outputs between 20 and 100 mV, and these low voltage outputs tend to be corrupted with noise. As a result, the voltages produced by the prior art devices must be amplified to produce useable outputs. However, signal amplification of noise results in “noisy” output which, inturn, causes signal distortion and inaccurate pressure wave readings.

For these reasons, it would be advantageous to have an infrasonic pressure wave sensor which is highly sensitive to a wide spectrum of low frequency pressure waves while still generating a high voltage that does not require problematic amplification of the signal. This result has been achieved with the present invention.

### SUMMARY OF THE INVENTION

An infrasonic sensor for detecting pressure wave signatures in accordance with the present invention comprises a Doppler transceiver utilizing a microwave emitting device, such as a Gunn diode, and a microwave receiving device, such as a receiver diode.

The infrasonic sensor for detecting pressure wave signatures in accordance with the present invention also comprises a reflective diaphragm, such as a conductive rubber or conductive plastic diaphragm. The microwave emitting device and microwave receiving device cooperate to measure the vibratory deflections in the reflective diaphragm as the reflective diaphragm is exposed to infrasonic pressure waves.

The infrasonic sensor for detecting pressure wave signatures in accordance with the present invention further comprises an apparatus capable of yielding a 2 V signal while remaining extremely sensitive to pressure waves having a frequency of less than 1 Hz.

### BRIEF DESCRIPTION OF THE DRAWINGS

In the accompanying drawings:

FIG. 1 is a plan view of the general arrangement of the components of the preferred embodiment of the present invention.

FIG. 2 is a graph illustrating how RF energy reflected from diaphragm 4 of FIG. 1 will vary based on deflection of the diaphragm.

### DESCRIPTION OF THE PREFERRED EMBODIMENT

The following illustrative description of the present invention is provided to facilitate an understanding of the invention, and is not intended to limit the present invention to any specific form.

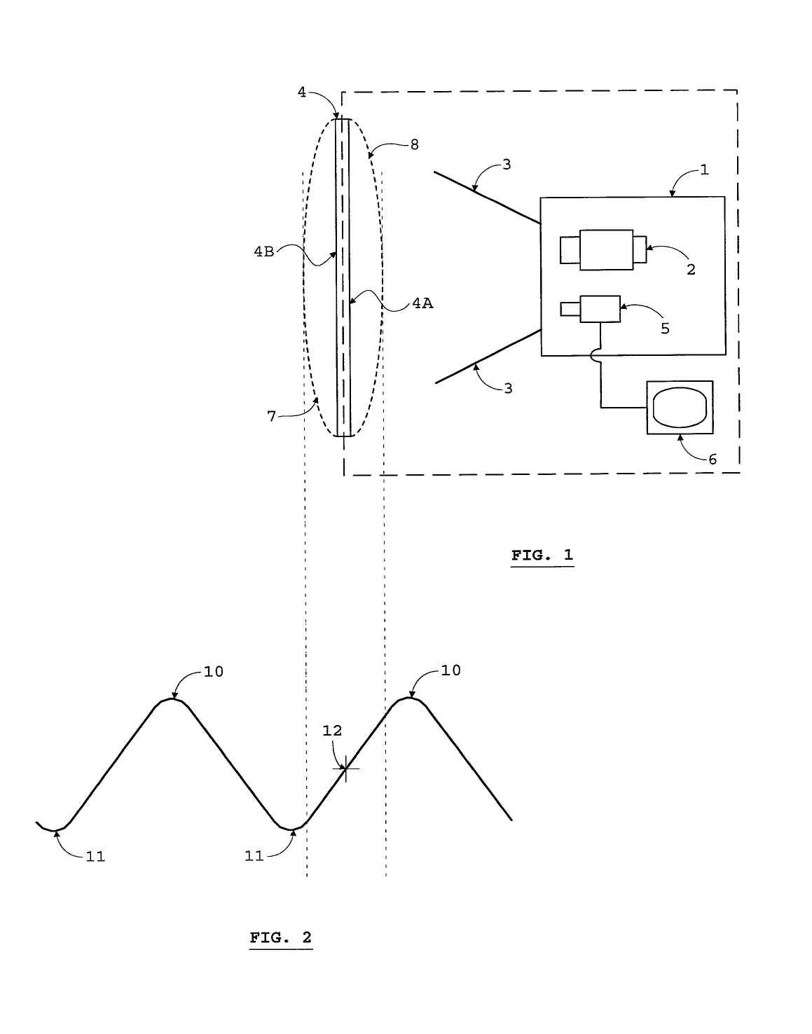

With reference to FIG. 1, an embodiment of the present invention comprises a Doppler transceiver 1 employing a Gunn diode 2 to emit an RF, e.g., microwave, signal. Doppler transceiver 1 is not used in its Doppler mode of operation, but rather is used to measure reflected energy, as discussed below. The emitted signals impinge on diaphragm 4, and portions of these signals are reflected off the internal surface 4A of diaphragm 4 to receiver diode 5 via waveguides 3. The receiver diode 5 receives these reflected signals and produces an analog signal in response thereto. A digitizer 6 may be employed to convert the analog signal of the output of receiver diode 5 into a digital format useable by a programmable logic controller (not shown).

When a pressure wave is generated by an external source, the pressure wave impinges on external face 4B of the diaphragm 4, and the pressure wave causes the diaphragm 4 to deflect. The amplitude of the mechanical deflection of the surface of the diaphragm 4 is detected as follows: When the amplitude of the diaphragm deflection is outwardly away from the Doppler transceiver 1, as illustrated by reference designator 7 in FIG. 1, the time the signal travels from the emitting Gunn diode 2 to the diaphragm 4 and back to the receiver diode 5 is relatively longer than when the diaphragm is stationary. When the amplitude of the diaphragm deflection is inwardly towards the Doppler transceiver 1, as illustrated by reference designator 8 in FIG. 1, the time the signal travels from the emitting Gunn diode 2 to the diaphragm 4 and back to the receiver diode 5 is relatively shorter than when the diaphragm is stationary. The absolute value of the difference between the “deflection trip” time and the “non-deflection trip” time is therefore directly proportional to the intensity of the external pressure wave. The receiver diode 5 produces a voltage in direct proportion to this trip time, and therefore the voltage produced by receiver diode 5 is also directly proportional to the intensity of the pressure wave.

With reference to both FIGS. 1 and 2, diaphragm 4 is preferably positioned with respect to receiver diode 5 as follows: When diaphragm 4 is stationary, reflected RF energy sensed by receiver diode 5 will have a magnitude 12, which is half-way between: (a) the magnitude 10 of the maximum reflected RF energy that is sensed when the diaphragm 4 has its maximum inward deflection; and (b) the magnitude 11 of the minimum reflected RF energy that is sensed when the diaphragm 4 has its maximum outward deflection. Stated differently, the reflected RF energy reaching receiver diode 5 is at the half-power point when the diaphragm 4 is stationary, based on the frequency of the RF signal emitted by Doppler transceiver 1.

While conductive rubber is the preferred material for diaphragm 4, other materials may be used for diaphragm 4 including conductive plastic and metallic diaphragms.

What is claimed is:

1. An apparatus for detecting pressure waves, comprising:
an emitting device for emitting a signal;
a diaphragm on which the signals from the emitting device impinge and from which a portion of said signals are reflected; and
a receiving device which receives signals reflected from the diaphragm and produces an output representative of the magnitude of the pressure wave.

2. The apparatus of claim 1, wherein said emitting and receiving devices comprise a Doppler transceiver which is used to generate energy and to measure reflected energy.

3. The apparatus of claim 2, wherein the emitting device comprises a Gunn diode.

4. The apparatus of claim 2, wherein the receiving device comprises a receiver diode.

5. The apparatus of claim 1, wherein the emitting device emits a microwave signal.

6. The apparatus of claim 1, wherein the reflective diaphragm is a conductive rubber diaphragm.

7. The apparatus of claim 1, wherein the reflective diaphragm is a conductive plastic diaphragm.

8. The apparatus of claim 1, further comprising a digitizer for receiving the output from the receiving device and generating a digital output of that signal.

9. The apparatus of claim 1, wherein said pressure waves are infrasonic pressure waves.

10. A method for detecting pressure waves, comprising the steps of:
disposing a diaphragm such that an externally generated pressure wave causes the diaphragm to deflect;
providing an emitting device to produce signals which impinge on and are reflected from the diaphragm;
receiving a portion of the reflected signals by a receiving device; and
generating an output signal from the receiving device which is representative of the magnitude of the pressure wave.

11. The method of claim 10, wherein said method further comprises the step of converting the output signal of the receiving device into a digital output signal.

12. The method of claim 10, wherein the diaphragm is a conductive rubber diaphragm.

13. The method of claim 10, wherein the diaphragm is a conductive plastic diaphragm.

14. The method of claim 10, wherein said emitting device comprise a Doppler transceiver which is used to generate energy and to measure reflected energy.

15. The method of claim 14, wherein the emitting device comprises a Gunn diode.

16. The method of claim 10, wherein the pressure wave comprises an infrasonic pressure wave.

17. The apparatus of claim 1, wherein the reflective diaphragm is metallic.
